(19) United States
(12) Patent Application Publication
(10) Pub. No.: US 2005/0280984 A1
(43) Pub. Date: Dec. 22, 2005

(54) Tablet PC and base member coupling arrangement

(75) Inventors: Chao-Ming Huang, Taipei City (TW); Wen-Chieh Wang, Taipei City (TW); Chun-Hao Hsu, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/909,346

(22) Filed: Aug. 3, 2004

(30) Foreign Application Priority Data
Jun. 18, 2004 (TW) 093209639

(51) Int. Cl. G06F 1/16

(52) U.S. Cl. 361/686

(57) ABSTRACT

A tablet PC and base member coupling arrangement is constructed to include a tablet PC, which has a coupling block protruded from the back side and an electric connector at the bottom side, and a base member, which has a top cradle for holding the tablet PC in a tilt position for operation, which cradle has a back panel, a bottom panel for supporting the tablet PC on the back panel, two upright sliding tracks at two distal ends of the bottom panel in front of the back panel for receiving the tablet PC, a coupling recess for receiving the coupling block to hold the tablet PC firmly in the upright sliding track, and an electric terminal installed in the bottom panel for receiving the electric connector of the tablet PC.

### BACKGROUND OF THE INVENTION

1. Field of the Invention

The present invention relates to a coupling structure and more specifically, to such a coupling structure for securing a tablet PC to a base member.

2. Description of Related Art

Following the dramatic growth of the notebook computer market and the approach of desk computer market saturation, the tablet PC is regarded as the trend of the next generation due to its advantages of high mobility and operation conveniences in the functions of touch-control input and digital ink.

Normally, a tablet PC user will hold the tablet PC with one hand and then operate the tablet PC with the other hand. However, it is inconvenient to operate a tablet PC on the top of a table when sitting on the chair because putting a tablet PC on the top of a table limits the user's view angle. In this case, a cradle or the like may be used to support the tablet PC at a tilt angle for operation. A conventional cradle for this purpose simply provides a holder for accommodating the tablet PC, and the tablet PC may be easily knocked out of place by the user during operation.

### SUMMARY OF THE INVENTION

The present invention has been accomplished under the circumstances in view. It is therefore the main object of the present invention to provide a tablet PC and base member coupling arrangement, which enables the tablet PC to be quickly detachable from and firmly connectable to the base member by means of the engagement between a protruding coupling section and a corresponding recessed coupling section.

To achieve these and other objects of the present invention, the tablet PC and base member coupling arrangement comprises a tablet PC having a predetermined thickness, and a base member having a cradle fixedly provided at the top for accommodating the tablet PC. The cradle comprises a back panel, a bottom panel forwardly extended from a bottom side of the back panel and adapted to support the tablet PC on the back panel, two upright slides symmetrically disposed at two distal ends of the bottom panel in front of the back panel and adapted to receive the tablet PC, the upright sliding tracks defining therein a receiving width greater than the thickness of the tablet PC, at least one second coupling section formed in a front side of the back panel, and an electric terminal means installed in the bottom panel. The tablet PC comprises at least one first coupling section formed at a back wall thereof for engaging the at least one second coupling section upon insertion of the tablet PC into the cradle, and an electric connector provided at a bottom side thereof for connection to the electric terminal means upon insertion of the tablet PC into the cradle. The at least one first coupling section of the tablet PC each is a protruding coupling block, and the at least one second coupling section of the cradle each is a coupling recess for receiving the corresponding protruding block of the tablet PC. The protruding coupling block and the coupling recess can be made having a rectangular shape that may extend horizontally, vertically, or obliquely. Alternatively, the protruding coupling block and the coupling recess can be made having a circular shape.

### BRIEF DESCRIPTION OF THE DRAWINGS

FIG. 1 is an exploded view of the preferred embodiment of the present invention;

FIG. 2 is a schematic drawing of the preferred embodiment of the present invention, showing the tablet PC installed in the cradle at the base member; and

FIG. 3 is a schematic sectional view of the preferred embodiment of the present invention.

### DETAILED DESCRIPTION OF THE PREFERRED EMBODIMENT

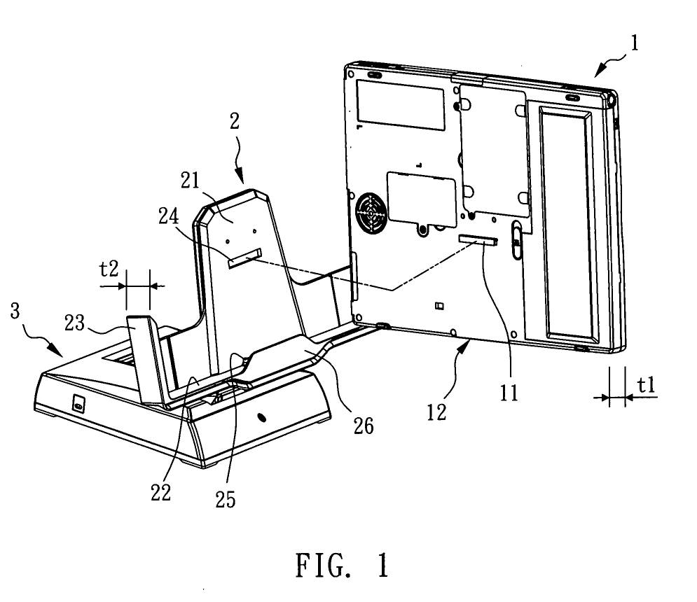

Referring to FIG. 1, a cradle 2 is provided at the top side of a base member 3 for supporting a tablet PC 1 at a viewing angle convenient for operation by the user. As illustrated, the tablet PC 1 has a predetermined thickness t1, a coupling section 11 at the back side, and an electric connector 12 at the bottom side. The cradle 2 comprises a back panel 21, a bottom panel 22, two upright sliding tracks 23, a front stop plate 26, and a coupling section 24 provided at the front side of the back panel 21 for receiving the coupling section 11 of the tablet PC 1. The bottom panel 22 is forwardly protruded from the bottom side of the back panel 21, having an electric terminal 25 installed therein for receiving the electric connector 12 of the tablet PC 1. The sliding tracks 23 define therein a receiving width t2 slightly greater than the thickness t1 of the tablet PC 1. Therefore, the tablet PC 1 can be inserted into the sliding tracks 23 and supported on the bottom panel 22 between the back panel 21 and the front stop plate 26.

In order to meet the market requirements of modem electronic devices, for example being lightweight and compact, the exterior of regular tablet PC is minimized and thus the interior space is fully utilized. Therefore, the invention has the coupling section 11 of the tablet PC 1 designed in a protruded form and the coupling section 24 of the cradle 2 in a recessed form matching the protruding coupling section 11 of the tablet PC 1, i.e., the coupling section 24 of the cradle 2 is a female coupling section and the coupling section 11 of the tablet PC 1 is a male coupling section engageable into the female coupling section 24 of the cradle 2. If the tablet PC has a sufficient thickness, the coupling section of the tablet PC can be designed to be a female coupling section for receiving the male coupling section at the cradle. According to the present preferred embodiment, the male coupling section 11 of the tablet PC 1 is a rectangular coupling block perpendicularly protruded from the back side of the tablet PC 1 and extended in a transverse (horizontal) direction, and the female coupling section 24 of the cradle 2 is a rectangular blind hole formed in the front surface of the back panel 21 and extended in transverse (horizontal) direction. As an alternative form of the present invention, the tablet PC can be made having multiple male (or female) coupling sections and the cradle can be made having multiple female (or male) coupling sections matching the male (or female) coupling sections of the tablet PC; or the coupling sections of the tablet PC and the cradle can be designed extending in vertical or oblique directions. The electric connector 12 of the tablet PC 1 can be a power connector or an electric connector, or the combination of a power connector and an electric connector for receiving power supply and/or electric signal from the electric terminal 25 of the cradle 2.

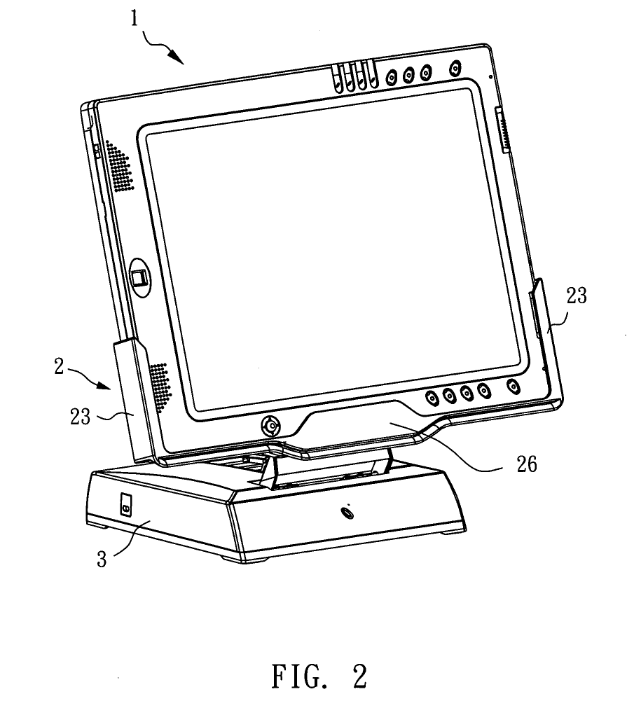

To use the tablet PC 1 on the cradle 2, the tablet PC 1 is attached to the back panel 21 of the cradle 2 and then the tablet PC 1 is moved downwards to insert the tablet PC 1 into the sliding tracks 23 and to further force the male coupling section 11 of the tablet PC 1 into engagement with the female coupling section 24 of the cradle 2 and the electric connector 12 of the tablet PC 1 into electric connection with the electric terminal 25. When installed, as shown in FIG. 2, the tablet PC 1 is firmly supported on the bottom panel 22 between the back panel 21 and the front stop plate 26, and the front stop plate 26 prohibits the tablet PC 1 from falling out of the bottom panel 22.

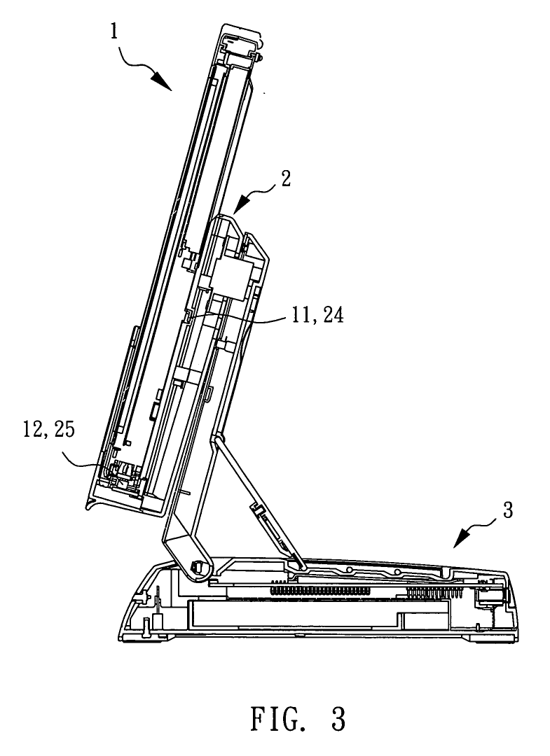

Referring to FIG. 3, after installation of the tablet PC 1 in the cradle 2, the male coupling section 11 of the tablet PC 1 and the female coupling section 24 of the cradle 2 are firmly connected together, and the electric connector 12 of the tablet PC 1 and the electric terminal 25 are positively electrically connected together.

To remove the tablet PC 1 from the cradle 2, the tablet PC 1 is pulled forwards from the back panel 21 to disengage the male coupling section 11 of the tablet PC 1 from the female coupling section 24 of the cradle 2, and then the tablet PC 1 is lifted from the cradle 2. Because the male coupling section 11 of the tablet PC 1 is a protruded section and the female coupling section 24 of the cradle 2 is a recessed section matching the protruded male coupling section 11 of the tablet PC 1 and because the receiving width t2 is slightly greater than the thickness t1 of the tablet PC 1, the tablet PC 1 can be pulled forwards from the back panel 21 to disengage the male coupling section 11 of the tablet PC 1 from the female coupling section 24 of the cradle 2 without much effort.

As indicated above, the tablet PC and base member coupling arrangement is a user-friendly design that enables the user to quickly detach and firmly connect the tablet PC to the base member.

Although the present invention has been explained in relation to its preferred embodiment, it is to be understood that many other possible modifications and variations can be made without departing from the spirit and scope of the invention as hereinafter claimed.

1. A tablet PC and base member coupling arrangement comprising:
a tablet PC, the tablet PC having a predetermined thickness; and
a base member, the base member comprising a cradle fixedly provided at a top side thereof and adapted to accommodate the tablet PC;
wherein the cradle comprises a back panel, a bottom panel forwardly extended from a bottom side of the back panel and adapted to support the tablet PC on the back panel, two upright slides symmetrically disposed at two distal ends of the bottom panel in front of the back panel and adapted to receive the tablet PC, the upright sliding tracks defining therein a receiving width greater than the thickness of the tablet PC, at least one second coupling section formed in a front side of the back panel, and an electric terminal means installed in the bottom panel; the tablet PC comprises at least one first coupling section formed at a back wall thereof for engaging the at least one second coupling section upon insertion of the tablet PC into the cradle, and an electric connector provided at a bottom side thereof for connection to the electric terminal means upon insertion of the tablet PC into the cradle.

2. The tablet PC and base member coupling arrangement as claimed in claim 1, wherein the at least one first coupling section of the tablet PC each is a protruding block protruded from the back side of the tablet PC, and the at least one second coupling section of the cradle each is a coupling recess formed in the front side of the back panel for receiving one protruding block of the tablet PC.

3. The tablet PC and base member coupling arrangement as claimed in claim 2, wherein the protruding block is a rectangular block, and the coupling recess is a recessed rectangular hole.

4. The tablet PC and base member coupling arrangement as claimed in claim 2, wherein the protruding block is a circular block, and the coupling recess is a recessed circular hole.

5. The tablet PC and base member coupling arrangement as claimed in claim 2, wherein the protruding block and the coupling recess respectively extend in horizontal direction.

6. The tablet PC and base member coupling arrangement as claimed in claim 1, wherein the cradle further comprises a front stop plate upwardly extended from a front side of the bottom panel.
